(19) United States
(12) Patent Application Publication
(10) Pub. No.: US 2014/0089952 A1
(43) Pub. Date: Mar. 27, 2014

(54) OPTICAL PICKUP

(71) Applicant: HITACHI MEDIA ELECTRONICS CO., LTD., Oshu-shi (JP)

(72) Inventors: Katsuhiko KIMURA, Kasumigaura (JP); Junichi SENGA, Yokohama (JP); Hidenao SAITO, Yokohama (JP)

(73) Assignee: Hitachi Media Electronics Co., Ltd., Oshu-shi (JP)

(21) Appl. No.: 13/849,569

(22) Filed: Mar. 25, 2013

(30) Foreign Application Priority Data
Sep. 27, 2012 (JP) 2012-213381

(51) Int. Cl. G11B 7/09

(52) U.S. Cl. CPC G11B 7/093
USPC 720/681

(57) ABSTRACT

An optical pickup includes an objective lens which converges light on an optical disc, a lens holder to which the objective lens is attached, a focusing coil and a tracking coil wound around the lens holder, magnets arranged to face two side faces of the lens holder parallel to a radial direction of the optical disc, supporting members which support the lens holder, and supporting member fixation parts provided on two side faces of the lens holder orthogonal to the radial direction of the optical disc. The focusing coil is wound on parts of the lens holder on both sides of the lens holder in regard to the radial direction of the optical disc so that each portion of the focusing coil on each side is wound around a winding central axis extending in a direction parallel to the optical axis of the objective lens.

### BACKGROUND OF THE INVENTION

1. Field of the Invention

The present invention relates to an optical pickup for an optical disc drive for reading out information recorded on a recording surface of an optical disc and/or recording information on an optical disc.

2. Description of the Related Art

An optical pickup as background technology of this technical field has been described in JP-2009-187619-A, for example. JP-2009-187619-A describes a configuration for directly winding focusing coils and tracking coils around a lens holder of the optical pickup. In this configuration, a gap exists between each focusing coil and each extending surface of the lens holder (around which each tracking coil is wound), between each focusing coil and an adjacent wire supporting part, and between each focusing coil and an adjacent post protruding from the lens holder (see Paragraph 0036 and FIG. 2).

### SUMMARY OF THE INVENTION

In the configuration of JP-2009-187619-A, the wire supporting parts for fixing wires protrude from side faces of the lens holder and extend downward. Further, the posts, on which coil-winding protrusions (to which ends of the wires are soldered) have been formed, also protrude from the side faces of the lens holder and extend downward similarly to the wire supporting parts. Since the wire supporting parts and the posts protrude from the side faces of the lens holder and extend downward as described above, the gap has to be formed between each focusing coil and the adjacent wire supporting part and between each focusing coil and the adjacent post in order to make it possible to wind the focusing coils around the lens holder. However, the formation of the gaps leads to a decrease in the lengths of the focusing coils since the external shape of the lens holder is restricted by the prescribed dimensions of the apparatus. Thus, enhancement of the driving force generated by the focusing coils has not been sufficiently taken into consideration in JP-2009-187619-A.

It is therefore the primary object of the present invention to provide an optical pickup having a configuration for directly winding the coils around the lens holder and also being capable of enhancing the driving force generated by the coils.

In order to achieve the above object, an aspect of the present invention provides an optical pickup comprising: an objective lens which converges light on an optical disc; a lens holder to which the objective lens is attached; a focusing coil and a tracking coil which are wound around the lens holder; magnets which are arranged to face two side faces of the lens holder parallel to a radial direction of the optical disc; supporting members which support the lens holder; and supporting member fixation parts which are provided on two side faces of the lens holder orthogonal to the radial direction of the optical disc. In the optical pickup, the focusing coil is wound on parts of the lens holder on both sides of the lens holder in regard to the radial direction of the optical disc so that each portion of the focusing coil on each side is wound around a winding central axis extending in a direction parallel to the optical axis of the objective lens. The tracking coil is wound on central parts of the two side faces of the lens holder parallel to the radial direction of the optical disc. A gap exists between the focusing coil and the tracking coil. The focusing coil is wound between the supporting member fixation parts.

Preferably, the magnets are arranged on one side and on the other side in regard to the radial direction of the optical disc. The polarity of the surface of each magnet facing the lens holder is varied depending on whether the magnet is arranged on the one side or on the other side. The focusing coil is wound between the supporting member fixation parts in regard to the optical axis direction of the objective lens.

Preferably, the optical pickup has coil-winding protrusions to which ends of the focusing coil and the tracking coil are wound. The coil-winding protrusions protrude in the axial direction of the supporting members from a side face of the lens holder parallel to the radial direction of the optical disc.

Preferably, end faces of the focusing coil far from the objective lens in regard to the radial direction of the optical disc are situated at positions farther from the optical axis of the objective lens than the coil-winding protrusions.

Preferably, end faces of the focusing coil far from the objective lens in regard to the radial direction of the optical disc are situated at positions farther from the optical axis of the objective lens than the supporting members.

Preferably, the gap between the focusing coil and the tracking coil is formed to secure a space on the plane of the winding of the focusing coil between a first circle having a radius specified as the distance from the winding central axis of the focusing coil to outer corners of the contour of the focusing coil and a second circle having a radius specified as the distance from the winding central axis of the focusing coil to the parts of the lens holder where the tracking coil is wound.

In order to achieve the above object, another aspect of the present invention provides an optical pickup comprising: an objective lens which converges light on an optical disc; a lens holder to which the objective lens is attached; a focusing coil and a tracking coil which are wound around the lens holder; magnets which are arranged to face two side faces of the lens holder parallel to a radial direction of the optical disc; supporting members which support the lens holder; and supporting member fixation parts which are provided on two side faces of the lens holder orthogonal to the radial direction of the optical disc. In the optical pickup, the magnets are arranged on one side and on the other side in regard to the radial direction of the optical disc. The polarity of the surface of each magnet facing the lens holder is varied depending on whether the magnet is arranged on the one side or on the other side. The focusing coil is wound on parts of the lens holder on both sides of the lens holder in regard to the radial direction of the optical disc so that each portion of the focusing coil on each side is wound around a winding central axis extending in a direction parallel to the optical axis of the objective lens. The tracking coil is wound on central parts of the two side faces of the lens holder parallel to the radial direction of the optical disc. A space is secured on the plane of the winding of the focusing coil between a first circle having a radius specified as the distance from the winding central axis of the focusing coil to outer corners of the contour of the focusing coil and a second circle having a radius specified as the distance from the winding central axis of the focusing coil to the parts of the lens holder where the tracking coil is wound.

According to the present invention, the lengths of parts of the focusing coil facing the magnets can be increased, by which an optical pickup comprising a focusing coil capable of generating greater driving force can be provided.

### BRIEF DESCRIPTION OF THE DRAWINGS

Other objects and advantages of the invention will become apparent from the following description of embodiments with reference to the accompanying drawings in which:

FIG. 1 is an exploded perspective view of an optical pickup in accordance with a first embodiment of the present invention;

FIG. 2 is a perspective view of a lens holder of the optical pickup in accordance with the first embodiment of the present invention;

FIG. 3 is a top view of the optical pickup in accordance with the first embodiment of the present invention;

FIG. 4 is a perspective view of the optical pickup in accordance with the first embodiment of the present invention;

FIG. 5 is a front view of the lens holder in accordance with the first embodiment of the present invention;

FIG. 6 is a cross-sectional view of the lens holder in accordance with the first embodiment of the present invention;

FIG. 7A is a perspective view of a lens holder of an optical pickup in accordance with a second embodiment of the present invention; and

FIG. 7B is a front view of the lens holder in accordance with a second embodiment of the present invention.

### DESCRIPTION OF THE PREFERRED EMBODIMENTS

Referring now to the drawings, a description will be given in detail of preferred embodiments in accordance with the present invention. In the following description, components that are assigned identical reference characters in the drawings are those having the same functions, and thus explanation of such equivalent components can be omitted when an explanation has already been given of the reference character.

### First Embodiment

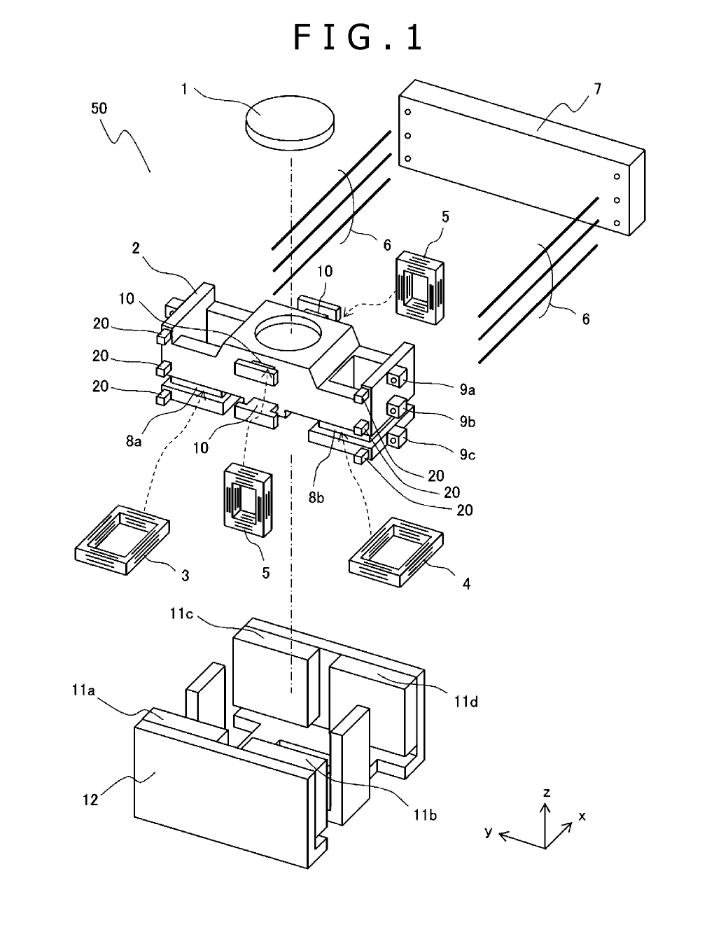

FIG. 1 is an exploded perspective view showing an objective lens driving apparatus 50 of an optical pickup in accordance with a first embodiment of the present invention. The z direction in FIG. 1 corresponds to the optical axis direction of an objective lens 1 and a focusing direction in which the objective lens 1 is moved toward and away from an optical disc (not shown). In regard to the z direction, the distance to the optical disc decreases with the increase in the z coordinate, that is, the upper part in FIG. 1 is closer to the optical disc than the lower part. The y direction corresponds to a radial direction of the optical disc and a tracking direction in which the objective lens 1 is moved and positioned with respect to the intended track of the optical disc. The x direction, which is orthogonal to both the y direction and the z direction, corresponds to a tangential direction of the optical disc. The direction of rotation around the x-axis corresponds to a tilt direction which indicates the tilting with respect to the radial direction of the optical disc.

The objective lens 1 is mounted on the upper surface of a lens holder 2. The lower part of the lens holder 2 has protruding parts 8a and 8b formed on both sides in regard to the radial direction of the optical disc (y direction). The lens holder 2 has two side faces orthogonal to the radial direction of the optical disc (y direction). Each of the side faces orthogonal to the y direction is provided with a first supporting member fixation part 9a, a second supporting member fixation part 9b and a third supporting member fixation part 9c (from top to bottom).

A focusing coil of the optical pickup is made up of a first focusing coil 3 and a second focusing coil 4. The first focusing coil 3 is wound around the protruding part 8a on one side of the lens holder 2 to surround a winding central axis extending in the direction parallel to the optical axis of the objective lens 1 (z direction). The second focusing coil 4 is wound around the protruding part 8b on the other side of the lens holder 2 to surround another winding central axis extending in the direction parallel to the optical axis of the objective lens 1 (z direction). In this case, each of the first and second focusing coils 3 and 4 is wound between the second supporting member fixation part 9b and the third supporting member fixation part 9c in regard to the optical axis direction of the objective lens 1 (z direction).

The lens holder 2 also has two side faces parallel to the radial direction of the optical disc (y direction). A central part of each of the side faces parallel to the y direction is provided with winding frames 10. A tracking coil 5 is wound around the winding frames 10 on each side face parallel to the y direction.

The lens holder 2 is supported by supporting members 6 to be movable with respect to a fixed part 7. Ends of the supporting members 6 on one side are put through the first supporting member fixation part 9a, the second supporting member fixation part 9b and the third supporting member fixation part 9c of the lens holder 2, respectively, and then fixed by using an adhesive agent or the like. The other ends of the supporting members 6 are fixed to the fixed part 7 by using an adhesive agent or the like.

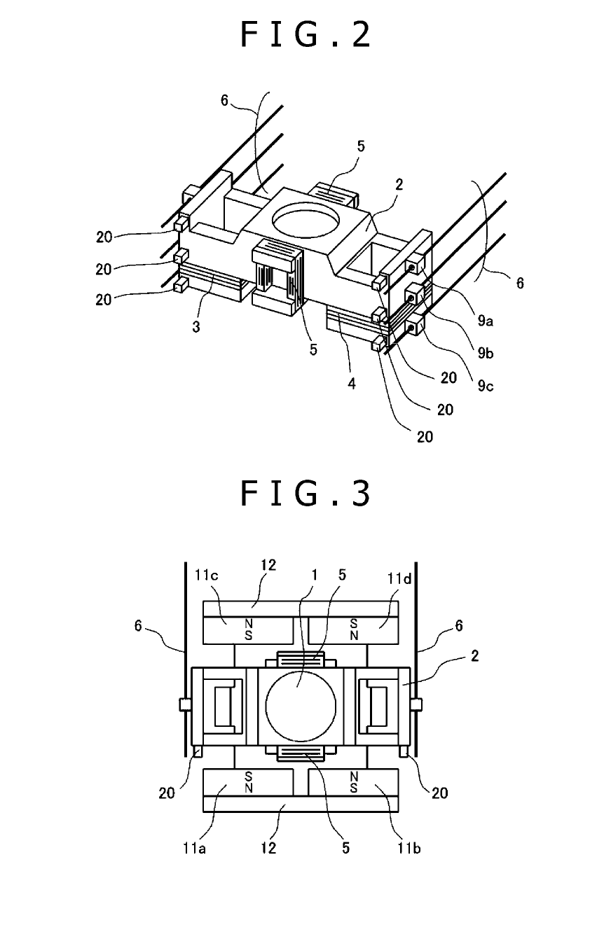

Two magnets 11a and 11b are arranged to face one of the side faces of the lens holder 2 parallel to the radial direction of the optical disc (y direction), while two magnets 11c and 11d are arranged to face the other side face of the lens holder 2 parallel to the y direction. The magnets 11a-11d are attached to a yoke 12 made of magnetic material. Incidentally, the reference characters “20” in FIG. 1 represent coil-winding protrusions, which will be explained below by referring to FIG. 2.

FIG. 2 is a perspective view showing a state in which the first focusing coil 3, the second focusing coil 4 and the tracking coils 5 have been wound around the lens holder 2 and the supporting members 6 have been brought through the supporting member fixation parts 9a, 9b and 9c.

The lens holder 2 has coil-winding protrusions 20 which protrude in the axial direction of the supporting members 6 from one side face of the lens holder 2 that is parallel to the radial direction of the optical disc (y direction) and farther from the fixed part 7 (shown in FIG. 1). Ends of the first focusing coil 3, the second focusing coil 4 and the tracking coils 5 are wound around prescribed coil-winding protrusions 20, respectively. Although not shown in FIG. 2, each of the ends of the first and second focusing coils 3 and 4 and the tracking coils 5, which has been wound around a corresponding coil-winding protrusion 20, is electrically connected to one end of a corresponding supporting member 6 by soldering or the like.

FIG. 3 is a top view showing the principal part of the objective lens driving apparatus 50. The magnets 11a-11d are arranged on both sides in regard to the radial direction of the optical disc (y direction). Specifically, the magnets 11a and 11c are arranged on one side and the magnets 11b and 11d are arranged on the other side in regard to the radial direction of the optical disc (y direction). The polarity of the surface of each magnet facing the lens holder 2 is varied depending on whether the magnet is arranged on the one side or on the other side. In the example of FIG. 3, the magnets 11a and 11c arranged on the one side in regard to the radial direction of the optical disc (y direction) have S-poles on their surfaces facing the lens holder 2 and N-poles on their surfaces attached to the yoke 12. In contrast, the magnets 11b and 11d arranged on the other side in regard to the radial direction of the optical disc (y direction) have N-poles on their surfaces facing the lens holder 2 and S-poles on their surfaces attached to the yoke 12.

Incidentally, the combination of N-poles and S-poles may also be set inversely to the example of FIG. 3.

In the objective lens driving apparatus 50 configured as above, when electric current is fed through the first focusing coil 3 and the second focusing coil 4, driving force in the focusing direction is caused by the electromagnetic interaction with the magnets 11a-11d. When electric current is fed through the tracking coil 5, driving force in the tracking direction is caused by the electromagnetic interaction with the magnets 11a-11d. Further, by setting a difference between the electric current supplied to the first focusing coil 3 and the electric current supplied to the second focusing coil 4, a difference is caused between the driving force generated by the first focusing coil 3 and the driving force generated by the second focusing coil 4. Torque in the tilt direction can be achieved by the difference.

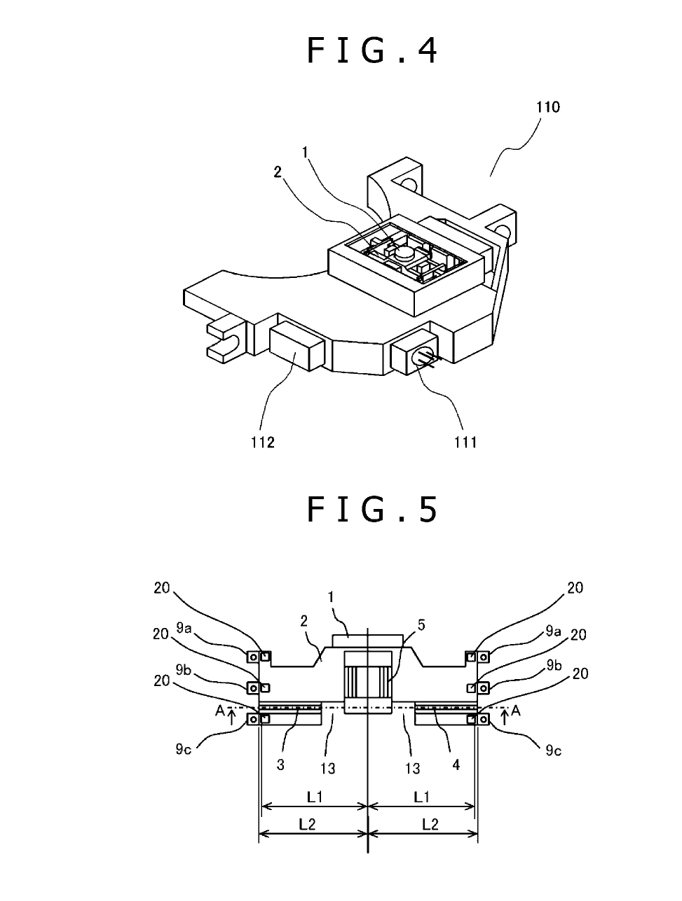

FIG. 4 is a perspective view showing the optical pickup 110 in accordance with the first embodiment of the present invention. A laser beam emitted from a laser emitting device 111 installed in the optical pickup 110 is converged on the optical disc (not shown) by the objective lens 1 and is reflected by the optical disc. The laser beam reflected by the optical disc propagates through the objective lens 1 and then enters a photodetector 112 of the optical pickup 110. A servo signal is detected from a signal acquired by the photodetector 112. According to the servo signal, driving currents are supplied to the first focusing coil 3, the second focusing coil 4 and the tracking coils 5 (see FIG. 1, FIG. 3, etc.) of the objective lens driving apparatus 50, by which the positioning control of the objective lens 1 is carried out. Meanwhile, the information stored on the optical disc is reproduced (e.g., played back) by detecting a reproduction signal from the signal acquired by the photodetector 112.

Principal parts of the first and second focusing coils 3 and 4 for generating the driving force in the focusing direction are the parts facing the magnets 11a-11d. Therefore, increasing the lengths of the parts of the first and second focusing coils 3 and 4 facing the magnets 11a-11d leads to enhancement of the driving force in the focusing direction.

FIG. 5 is a front view showing a state in which the first focusing coil 3, the second focusing coil 4 and the tracking coils 5 have been wound around the lens holder 2 and the objective lens 1 has been attached to the lens holder 2.

According to this embodiment, each of the first and second focusing coils 3 and 4 is wound between the second supporting member fixation part 9b and the third supporting member fixation part 9c in regard to the optical axis direction of the objective lens 1 (z direction). With this configuration, the need of forming the gap between each focusing coil and the adjacent wire supporting part (in which the supporting member fixation parts are connected together in a plate-like shape) or between each focusing coil and the adjacent post (as in JP-2009-187619-A) can be eliminated.

Further, in this embodiment, the coil-winding protrusions 20 protrude in the axial direction of the supporting members 6 from the side face of the lens holder 2 parallel to the radial direction of the optical disc (y direction). With this configuration, end faces of the first and second focusing coils 3 and 4 far from the objective lens 1 in regard to the radial direction of the optical disc (y direction) can be situated at positions farther from the optical axis of the objective lens 1 than the coil-winding protrusions 20.

In cases where the coil-winding protrusions 20 protrude in directions parallel to the radial direction of the optical disc (y direction) from side faces of the lens holder 2 orthogonal to the radial direction of the optical disc (y direction) differently from this embodiment (hereinafter referred to as a “comparative example”), the coil-winding protrusions 20 interfere with the first and second focusing coils 3 and 4, and thus the end faces of the first and second focusing coils 3 and 4 far from the objective lens 1 in regard to the radial direction of the optical disc (y direction) cannot be situated at positions farther from the optical axis of the objective lens 1 than the coil-winding protrusions 20.

Specifically, as shown in FIG. 5 illustrating the lens holder 2 in accordance with this embodiment, the distance L2 between the optical axis of the objective lens 1 and the end faces of the first and second focusing coils 3 and 4 far from the objective lens 1 in regard to the radial direction of the optical disc (y direction) can be set longer than the distance L1 between the optical axis of the objective lens 1 and the coil-winding protrusions 20.

With this configuration, the lengths of the parts of the first and second focusing coils 3 and 4 facing the magnets 11a-11d can be set longer than in the comparative example, by which the driving force generated by the first and second focusing coils 3 and 4 can be increased.

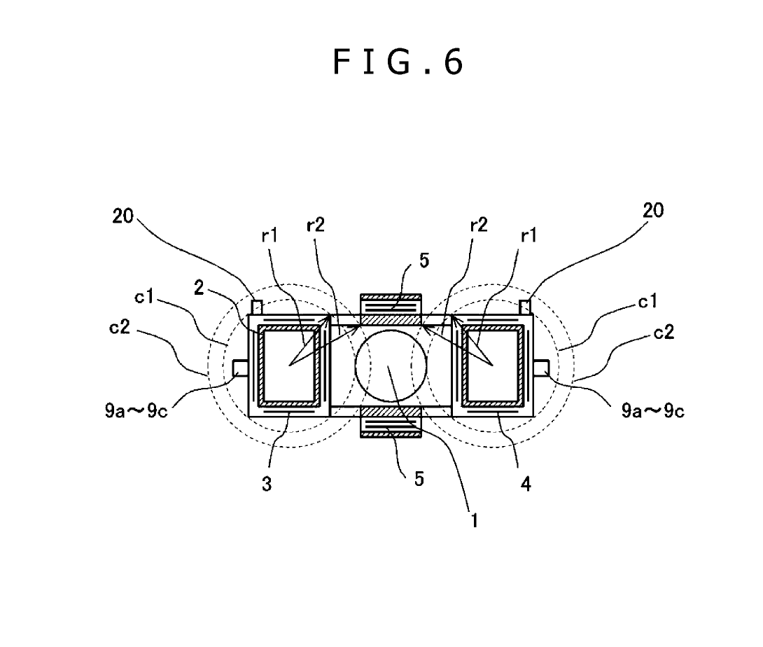

Next, other effects of this embodiment will be explained below referring to FIG. 6. FIG. 6 is a cross-sectional view showing the A-A cross section indicated in FIG. 5. Incidentally, the objective lens 1, the first through third supporting member fixation parts 9a-9c and the coil-winding protrusions 20, which do not actually exist on the A-A cross section, are drawn in FIG. 6 in order to clarify the two-dimensional positional relationship among the components.

As shown in FIG. 5, each of the first and second focusing coils 3 and 4 has a gap 13 between itself and the tracking coil 5. Thanks to the gaps 13, the first and second focusing coils 3 and 4 can be directly wound around the lens holder 2 by use of a coil winding machine by rotating an unshown nozzle (for supplying the coil wire) around each protruding part 8a, 8b (see FIG. 1) of the lens holder 2.

Further, referring to FIG. 6 showing the plane of the winding of the first and second focusing coils 3 and 4 (i.e., the plane on which the first and second focusing coils 3 and 4 are wound), it is possible to postulate a first circle c1 having a radius r1 specified as the distance from the winding central axis of the first focusing coil 3 to the outer corners of the contour of the first focusing coil 3 and a second circle c2 having a radius r2 specified as the distance from the winding central axis of the first focusing coil 3 to proximal ends of wall parts of the lens holder 2 where the tracking coils 5 are wound. The space between the first circle c1 and the second circle c2 can be considered to serve as or to have a space not interfered by other parts constituting the optical pickup. The same goes for the other side of the lens holder 2 having the second focusing coil 4.

With this configuration, the winding of each of the first and second focusing coils 3 and 4 around the lens holder 2 can be carried out with ease by rotating the unshown nozzle (for supplying the coil wire) along a circular orbit (with a radius r satisfying r1<r<r2) in the space between the first circle c1 and the second circle c2.

In the aforementioned configuration (as in the background technology) in which the nozzle has to pass through the gap between each focusing coil and the adjacent wire supporting part (in which the supporting member fixation parts are connected together in a plate-like shape) and the gap between each focusing coil and the adjacent post, the rotation of the nozzle along a circular orbit requires a considerably wide gap between each focusing coil and the wire support part and between each focusing coil and the post. Securing such wide gaps is substantially impossible in consideration of the dimensions of the apparatus. Thus, the orbit of the nozzle is necessitated to be in a rectangular shape in the aforementioned configuration of the background technology.

In cases of such a rectangular orbit, the traveling speed of the nozzle drops at the corners of the rectangular orbit since the nozzle has to temporarily stop at each corner and restart moving in a different direction.

In contrast, in cases of a circular orbit (with a radius r satisfying r1<r<r2) as in this embodiment, the nozzle can be moved at a constant speed and the time necessary for the coil winding can be shortened considerably compared to the rectangular orbit. In the configuration of this embodiment, for example, the coil winding time can be reduced by approximately 30% by use of the circular orbit compared to the rectangular orbit. This enables a substantial reduction in the manufacturing cost of the optical pickup. Incidentally, the “circular orbit” is not necessarily required to be a perfect circle in the strict sense. The circular orbit can be a substantially circular orbit as long as the nozzle is allowed to move at a constant speed.

### Second Embodiment

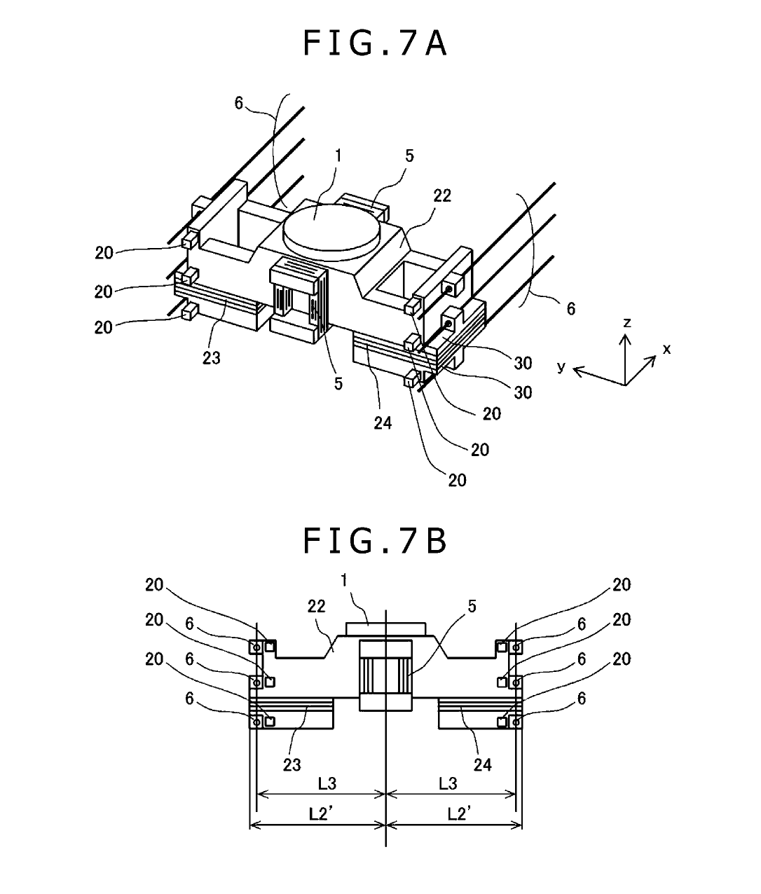

Next, a second embodiment of the present invention will be described with reference to FIG. 7.

FIG. 7A is a perspective view showing a state in which a first focusing coil 23, a second focusing coil 24 and the tracking coils 5 have been wound around a lens holder 22 and the supporting members 6 and the objective lens 1 have been attached to the lens holder 22. FIG. 7B is a front view showing the same state.

Each of the two side faces of the lens holder 22 orthogonal to the radial direction of the optical disc (y direction) is provided with winding frames 30 protruding in a direction separating from the objective lens 1. Each of the first and second focusing coils 23 and 24 is wound between the winding frames 30. The other configuration is equivalent to that in the first embodiment.

In this embodiment, the coil-winding protrusions 20 protrude in the axial direction of the supporting members 6 from the side face of the lens holder 22 parallel to the radial direction of the optical disc (y direction). Therefore, the winding frames 30 are allowed to protrude outward from each side face of the lens holder 22 orthogonal to the radial direction of the optical disc (y direction).

In the aforementioned case where the coil-winding protrusions 20 protrude in directions parallel to the radial direction of the optical disc (y direction) from the side faces of the lens holder 22 orthogonal to the radial direction of the optical disc (y direction) (as in the background technology) differently from this embodiment, the winding frames 30 cannot be formed to protrude outward from each side face of the lens holder 22 orthogonal to the radial direction of the optical disc (y direction) since the coil-winding protrusions 20 interfere with the winding frames 30.

In this embodiment, the outward protrusion of the winding frames 30 from each side face of the lens holder 22 orthogonal to the radial direction of the optical disc (y direction) is made possible by forming the coil-winding protrusions 20 to protrude in the axial direction of the supporting members 6. Consequently, the first and second focusing coils 23 and 24 are allowed to have longer parts extending in the radial direction of the optical disc (y direction) not only compared to the configuration of the background technology but also compared to the first embodiment.

Specifically, as shown in FIG. 7B, the distance L2′ between the optical axis of the objective lens 1 and the end faces of the first and second focusing coils 23 and 24 far from the objective lens 1 in regard to the radial direction of the optical disc (y direction) is longer than the distance L3 between the optical axis of the objective lens 1 and the supporting members 6.

With this configuration, the lengths of the parts of the first and second focusing coils 23 and 24 facing the magnets can be set still longer than in the first embodiment, by which the driving force generated by the first and second focusing coils 23 and 24 can be increased further.

It is to be noted that the present invention is not limited to the aforementioned embodiments, but covers various modifications. While, for illustrative purposes, those embodiments have been described specifically, the present invention is not necessarily limited to the specific forms disclosed. Thus, partial replacement is possible between the components of a certain embodiment and the components of another. Likewise, certain components can be added to or removed from the embodiments disclosed.

Note also that some or all of the aforementioned components, functions, processors, and the like can be implemented by hardware such as an integrated circuit or the like. Alternatively, those components, functions, and the like can be implemented by software as well. In the latter case, a processor can interpret and execute the programs designed to serve those functions. The programs, associated data tables, files, and the like can be stored on a stationary storage device such as a memory, a hard disk, and a solid state drive (SSD) or on a portable storage medium such as an integrated circuit card (ICC), an SD card, and a DVD.

Further note that the control lines and information lines shown above represent only those lines necessary to illustrate the present invention, not necessarily representing all the lines required in terms of products. Thus, it can be assumed that almost all the components are in fact interconnected.

What is claimed is:

1. An optical pickup comprising:
an objective lens which converges light on an optical disc;
a lens holder to which the objective lens is attached;
a focusing coil and a tracking coil which are wound around the lens holder;
magnets which are arranged to face two side faces of the lens holder parallel to a radial direction of the optical disc;
supporting members which support the lens holder; and
supporting member fixation parts which are provided on two side faces of the lens holder orthogonal to the radial direction of the optical disc, wherein:
the focusing coil is wound on parts of the lens holder on both sides of the lens holder in regard to the radial direction of the optical disc so that each portion of the focusing coil on each side is wound around a winding central axis extending in a direction parallel to the optical axis of the objective lens,
the tracking coil is wound on central parts of the two side faces of the lens holder parallel to the radial direction of the optical disc,
a gap exists between the focusing coil and the tracking coil, and
the focusing coil is wound between the supporting member fixation parts.

2. The optical pickup according to claim 1, wherein:
the magnets are arranged on one side and on the other side in regard to the radial direction of the optical disc,
the polarity of the surface of each magnet facing the lens holder is varied depending on whether the magnet is arranged on the one side or on the other side, and
the focusing coil is wound between the supporting member fixation parts in regard to the optical axis direction of the objective lens.

3. The optical pickup according to claim 2, wherein:
the optical pickup has coil-winding protrusions to which ends of the focusing coil and the tracking coil are wound, and
the coil-winding protrusions protrude in the axial direction of the supporting members from a side face of the lens holder parallel to the radial direction of the optical disc.

4. The optical pickup according to claim 3, wherein end faces of the focusing coil far from the objective lens in regard to the radial direction of the optical disc are situated at positions farther from the optical axis of the objective lens than the coil-winding protrusions.

5. The optical pickup according to claim 4, wherein end faces of the focusing coil far from the objective lens in regard to the radial direction of the optical disc are situated at positions farther from the optical axis of the objective lens than the supporting members.

6. The optical pickup according to claim 1, wherein the gap between the focusing coil and the tracking coil is formed to secure a space on the plane of the winding of the focusing coil between a first circle having a radius specified as the distance from the winding central axis of the focusing coil to outer corners of the contour of the focusing coil and a second circle having a radius specified as the distance from the winding central axis of the focusing coil to the parts of the lens holder where the tracking coil is wound.

7. An optical pickup comprising:
an objective lens which converges light on an optical disc;
a lens holder to which the objective lens is attached;
a focusing coil and a tracking coil which are wound around the lens holder;
magnets which are arranged to face two side faces of the lens holder parallel to a radial direction of the optical disc;
supporting members which support the lens holder; and
supporting member fixation parts which are provided on two side faces of the lens holder orthogonal to the radial direction of the optical disc, wherein:
the magnets are arranged on one side and on the other side in regard to the radial direction of the optical disc,
the polarity of the surface of each magnet facing the lens holder is varied depending on whether the magnet is arranged on the one side or on the other side,
the focusing coil is wound on parts of the lens holder on both sides of the lens holder in regard to the radial direction of the optical disc so that each portion of the focusing coil on each side is wound around a winding central axis extending in a direction parallel to the optical axis of the objective lens,
the tracking coil is wound on central parts of the two side faces of the lens holder parallel to the radial direction of the optical disc, and
a space is secured on the plane of the winding of the focusing coil between a first circle having a radius specified as the distance from the winding central axis of the focusing coil to outer corners of the contour of the focusing coil and a second circle having a radius specified as the distance from the winding central axis of the focusing coil to the parts of the lens holder where the tracking coil is wound.
